(19) United States
(12) Patent Application Publication
(10) Pub. No.: US 2020/0072133 A1
(43) Pub. Date: Mar. 5, 2020

(54) CAM ROTARY ENGINE POWER SYSTEM OF INTERNAL COMBUSTION TYPE

(71) Applicant: Dalian University of Technology, Dalian City, Liaoning Province (CN)

(72) Inventors: Shoulin SUN, Dalian City, Liaoning Province (CN); Yongning BIAN, Dalian City, Liaoning Province (CN); Yang YANG, Dalian City, Liaoning Province (CN); Lin WANG, Dalian City, Liaoning Province (CN); Guanglin ZHANG, Dalian City, Liaoning Province (CN); Pengfei HONG, Dalian City, Liaoning Province (CN)

(21) Appl. No.: 16/492,892

(22) PCT Filed: Mar. 12, 2018
(86) PCT No.: PCT/CN2018/078665

§ 371 Date: Sep. 10, 2019

(30) Foreign Application Priority Data
Mar. 23, 2017 (CN) 201710169154. 7

(51) Int. Cl. F02D 13/02; F02D 15/00; F01L 1/047; F02B 53/06; F01L 1/08; F01L 1/22; F01L 9/04; F01C 21/18

(52) U.S. Cl. CPC F02D 13/0215; F02D 15/00; F01L 1/047; F02B 53/06; F01L 2113/00; F01L 1/22; F01L 9/04; F01C 21/18; F01L 1/08

(57) ABSTRACT

A cam rotary engine power system of internal combustion type, making use of the cam and a plurality of cam followers to form cam mechanisms, and forming a plurality of circumferential distributed sealing working chambers with the inner-cavity-member, the external-rotating-surface-member and the end-cover-member. The volume of those chambers change with the relative rotation of the cam and the cam followers, in which the intake, compression, power and exhaust processes of the Otto cycle are completed by valve coordination. The chemical energy produced by gas combustion is directly converted into the mechanical energy of the rotor in the form of fixed axis rotation. The power system does not set the crankshaft of piston engine, and the high pressure gas directly drives the rotor to rotate and output power. The structure of this power system is relatively simple and its parameters can be adjusted in a wide range.

### FIELD OF THE INVENTION

The present invention relates to the engine field, and refers to an internal combustion rotary engine.

### BACKGROUND

Piston engine is the earliest internal combustion engine. It is characterized by the reciprocating straight line motion of the piston in the cylinder and the output of the crankshaft rotary motion through the crank slider mechanism. A piston engine completes four working processes of intake, compression, work and exhaust, that is the Otto cycle, in the cylinder within two turns of crankshaft rotation. It is generally believed that piston engine has the advantages of high thermal efficiency, compact structure, strong maneuverability and simple operation and maintenance. It is even considered that the power plant of piston engine, especially its mechanical structure, has reached the degree of peak pole. However, the fact is that piston engine's working phrase, during which power is output, accounts for only ¼ of the total working cycle, so the motion fluctuates greatly, so the working process must be maintained by flywheel, especially its thermal efficiency is only about 40%. Piston engine's structure is in almost the same form lacking of variability. The only way to improve power is by increasing the size or multiple sets of systems in parallel. Moreover, limited by the characteristics of crank slider mechanism, it is difficult to effectively use the chemical energy produced by work stroke: for example, the most powerful period of fuel explosive force is so close to crank's dead point, that, at this moment, the explosive force is mainly against internal friction, because the force arm is close to zero, can not produce the maximum driving torque; The length of the maximum force arm and the stroke of the piston depend on the preset length of the crank. Corresponding to the maximum force arm, the explosive force of the fuel has decreased a lot. The composition of the power mechanism of the Piston engine determines that it is impossible to fully convert the chemical energy of the fuel. This is also a fundamental reason why the efficiency of piston engine is difficult to improve.

Triangular rotary engine (also known as triangular piston rotary engine) is the only successful commercial rotary engine. Triangular rotary engine comprises one or more curved triangular rotors with constant-diameter characteristics, and a rotor housing having an elliptical-like inner cavity. Three side-walls of the rotor, with the inner wall of the rotor housing, can form three independent spaces, that is, combustion chamber. Through a crankshaft and gear meshing, the rotor is forced to planet rotation in the housing. When the rotor rotate, the inlet and exhaust orifice are exposed regularly, so that the Otto cycle can be completed one after another in each of the three combustion chambers without the need to be equipped with special engine valves like the piston engines. The rotor, instead of the piston, converts the pressure into a rotating motion output. The rotor rotates continuously in one direction, rather than changing the direction violently. The engine ignites three times during rotor's rotating one turn. The triangular rotary engine solves the problems of end face sealing and radial sealing, simplifies the structure, has the advantages of small volume, light weight, quiet operation, low noise and uniform torque characteristics. However, there are still some key problems, such as excessive machining requirements of core parts, too sensitive to wear, difficult to adjust compression ratio, low thermal efficiency and so on, and the fuel utilization rate is still difficult to improve. At the same time, similar to piston engine, the expansibility of triangular rotary engine structure is also limited. In addition, when the expansion force produced by the fuel is transformed into the power of the output shaft, there are natural defects in the transmission of the force. Although the expansion force can promote the rotation of the rotor, it is difficult to improve the torque of the rotor shaft by its acting force, and the internal friction ratio is too high.

There are many kinds of fuels used in internal combustion engines, such as gasoline, diesel, kerosene, natural gas, LPG, coal gas, hydrogen and so on. There are two ways of fuel supply for power system in the working process of internal combustion engine: one is fuel gasification or atomization mixed with oxidant (usually air) to enter the combustion chamber, the other is that the fuel is injected separately through the filling device and does not enter the combustion chamber synchronously with the oxidant. There are also two ways to ignite fuel: one is to use spark plugs or other ignition devices to ignite, the other is spontaneous combustion after compression and heating, such as diesel oil.

### SUMMARY OF THE INVENTION

The present invention is inspiration result modified from the application of cam mechanism in pump and motor structure to meet the special requirements of Otto cycle of internal combustion engine. After breaking through the key technologies of orderly transformation of four processes, a power device composition principle of rotary engine based on combined cam mechanism is proposed. In this structure, there are some working chambers in which volume change occurs accompanying the continuous concentric rotation of the rotor, so as to realize the classical process of Otto cycle and directly to absorb the pressure energy produced by fuel combustion.

The primary design idea is as follows: it can make used of facts that rise and fall intervals of a cam's contour profile cause size change of the cam surface, and that an annular clearance with varied dimension can then be formed by encircling the cam with an inner surface of an inner cavity rotating surface member, the outer surface of an external rotating surface member and corresponding end cover members, while all coupled surfaces form the contact sealing relationship except the cam contour profile. The cam is fixed with one of the inner cavity member or the external rotating surface member and rotated relative to the other, and a set of cam followers are installed on one of the inner cavity member or the external rotating surface member which is not fixed with the cam. Sealing contact can be formed by using the higher pair joints between the cam followers and the smooth cam contour profile surface, so as to the annular clearance is separated into a plurality of sealing working chambers along the circumferential direction. Under the control of valve controllers, the valves are used to connect the inlet and exhaust ports in each chambers, and to control flow direction of gas in an orderly manner. When the volume of a working chamber increases, the intake-phrase can be realized if the inlet port is opened while exhaust is closed; otherwise the requirements of the expansion phrase can be met if both inlet and exhaust ports are closed. Comparatively, when working chamber's volume is reduced, the exhaust phase can be realized if the exhaust port is opened and inlet closed; otherwise the requirements of the compression phase can be met if both inlet and exhaust ports are closed. By controlling the timing of the valve switch, the intake, compression, expansion and exhaust phases of Otto cycle can be completed periodically in each working chambers. In the expansion (power) stroke, the chemical energy produced by fuel combustion is acted on the cam contour profile and cam followers in the form of high pressure, so that the mechanical energy can be output by the two in the form of relative rotating motion.

The design of cam mechanism is diverse. The cam contour profile can be a radial cam formed on the surface of a base cylinder by a straight generatrix, or an axial cam on the end face of a cylinder. The cam contour profile can even be a spatial structure formed by rotating a complex generatrix around an axis of other rotating bodies, for example, by a spiral generatrix on a cylindrical surface, by an arc generatrix on the drum shape surface, by a straight generatrix on a conical or spherical surface. Even for the radial and axial cams, both outer or inner surface working contour profile ones are available. In addition, varying in profile shape, rise and fall interval and the number of dwell intervals leads to multifarious result, all of which can produce different design effects.

The type of cam follower motion also varies in translating follower, oscillating follower, and planar motion follower with sliding wobble composite. The structure for the followers varies according to motion of followers. The part of the follower which contacts the cam can be one of sharp edge, curve-faced, flat-faced, and roller. In order to adapt to the change of cam generatrix and meet the sealing requirements, if necessary, the cam follower can adopt combination structure, such as combination of multi-piece in length or width and the contacting ends can have swinging heads in order to keep contact sealing lines. The joints between cam followers and cam contour profile is simple if force closure is adopt by spring, hydraulic force, air pressure, electromagnetic force and other forces, especially when realized by hydraulic pressure and electromagnetic force, it is easy to carry out flexible control. In addition, form closure is also adaptable in the case of specific cam structure, at which time the follower's form-closed structure should have high dimensional accuracy or certain deformation compensation ability.

When used, either the members fixed to the cam or the members connected to the cam follower can be used as the rotor, that is, the rotating parts for the power output. On the premise of keeping the necessary end seal with the cam and the cam follower and of making a concentric relative rotation between the two, the end member can be fixed with one of the two or independent of the two.

The cam contour profile can be composed of one or more kinds of curves, such as straight line, circular arc, spline, sine and cosine curves, polynomial curves, elliptical curves and other commonly used curves of cam contours. The selection principle is that, during motion, the cam follower with which the cam mechanism is related should not get rigid impact and/or flexible impact, that is, no discontinuous change in the velocity and acceleration mathematical functions to be used to define the motion of the follower. This will be beneficial to the stability of the connection seal between the cam follower and the cam contour profile, and avoid the impact wear of the joint surface, so as to improve the service life.

It is better choices to set the high dwell section and/or the low dwell section, periods at high or low position of the cam contour profile to let the cam follower motionless, in order to realize a relatively simple motion of the cam follower and to reduce relative motion of the connection part, so as to reduce the wear and tear.

According to the necessity, a capture-release mechanism of cam follower (EMCF) is set up, and its function is to jam or release the follower in time in order to realize a flexible control of the working process. When the EMCF is realized by electromagnetic control or hydraulic control, the structure is simple, especially suitable for the case of large number of cam followers. Similarly, the valve controller should be realized by electromagnetic control or hydraulic control, and when the number of cam followers is small, it can also be realized by mechanical transmission.

In addition, according to the necessity of using fuel, the ignition device should be arranged in the corresponding position of the combustion chamber where the mixture reaches the specified compression ratio. If the timing of fuel filling is not synchronized with that of oxidant such as air, the fuel injection inlet of the fuel supplying device should be set in the corresponding interval between the intake process and the compression process.

One or more sets of power systems of the invention, combined with other auxiliary systems such as other lubrication systems, cooling systems, gas distribution systems, control systems, etc., can form a complete internal combustion rotary engine.

The cam rotary engine power system disclosed by the invention, as the core of a type of internal combustion engine, has at least the following visible advantages:

1. The power produced by combustion acts directly on the output rotor with fixed-axis rotation. No motion transformation process is needed, and the motion transmission chain is short, as the pressure energy produced by fuel combustion is absorbed directly by the rotor via the chambers continuous changing corresponding with the rotor' rotation, and so the transmission efficiency is improved.

2. The arm of the explosion pressure force of the fuel can be kept unchanged at the moment of the highest explosive pressure or at the later stage of combustion. So the explosion pressure can be fully utilized.

3. The system can realize the rotor's rotating non-eccentrically, and the system balance is easy to reach, so the motion is stable, without reciprocating parts, the power loss is small, the system vibration is small, and the low noise operation can be realized.

4. In the unified structure, flexible conversions of a variety of working modes can be realized through the cooperation of a control system, and the adaptability is very high, especially suitable for the flexible automatic control with the computer. Forward and reverse switch may even be realized.

5. The possibility of redesign of this system is very high, parameter range of regulating combustion performance and dynamic performance is wide, and the thermal efficiency is expected to be greatly improved, and the output form of external rotor or inner rotor can be designed.

6. The structure is simple and there is no need to use impeller and triangular rotor with high machining accuracy, so the manufacturing cost is low.

7. The classical four strokes of the Otto cycle are realized by volume change, and the operation of high and low speed is applicable. It is easy to do multiple work within a single rotation, the intake volume and the length of work stroke can be adjusted, and the output of low speed and high torque can be realized.

8. Small size, easy to achieve flattening and thinning, can adapt to different use of space needs. Less movable parts, insensitive to wear, easy to achieve automatic compensation, high reliability.

9. Multiple fuels can be used.

### DESCRIPTION OF THE DRAWINGS

FIG. 1, the front view of a basic structure, is a cross-sectional view through BB section of

FIG. 2 which is the top view of FIG. 1.

FIG. 2 corresponds to the A/A section of FIG. 1.

Description of the reference signs in FIG. 1 and FIG. 2:

e01—rotor housing, having a member with a inner cavity in which sliders are installed;

e02—a rotor comprised with a cam and a external rotating surface member;

e03—sliders as cam followers;

e04—end cover members;

e05—inlet and exhaust ports with valves;

e06—ignition devices;

e07—springs.

FIG. 3 is a schematic view showing a structure with. cam follower control device, which is shown by a perspective view with a partial cut.

Description of the reference signs in FIG. 3:

e01—outer rotor, formed by inner contour cam and a member having a inner cavity;

e02—external rotating surface member as central fixing frame, on which cam followers is installed;

e03—swingors as cam followers, whose quantity is 6;

e04—end cover members;

e05—inlet and exhaust ports with valves;

e06—ignition devices;

e07—slider capture-release device;

e08—valve linkage controller device.

FIG. 4 is a schematic view showing a structure with a slider cam follower and a cam inner rotor, which is shown by a perspective view with a partial cut.

Description of the reference signs in FIG. 4:

e01—frame constituted by rotor housing with inner cylindrical surface;

e02—rotor, constituted by central camshaft of external rotating surface member and a cam which has an outer plate contour profile;

e03—swingors as cam followers, whose quantity is 6;

e04—end cover members;

e05—inlet and exhaust ports with valves;

e06—ignition devices;

e07—slider capture-release device.

FIG. 5 is an illustrative diagram of a flexible control working process with the structure in FIG. 4. See Embodiment III for more details.

FIG. 6 is an anatomical diagram of a system structure based on an axial cam, cylindrical end face.

Description of the reference signs in FIG. 6:

e01—rotor housing with a cylindrical inner cavity;

e02—cylindrical camshaft;

e03—cylindrical end face cam; e02, e03 are fixed as an inside rotor;

e04—axial straight moving sliders , translating cam followers;

e05—end cover members;

e06—inlet and exhaust ports with valves.

FIG. 7 describes a kind of the system structure based on sphere.

Description of the reference signs in FIG. 7:

e01—rotor housing with a spherical inner cavity, which is divided into upper and lower parts, and the lower body is also acted as the end cover member for seal;

e02—an cam formed on a spherical body; e07—a central camshaft, external rotating surface member; e02 and e07 are combined into cam rotor;

e03—spherical swingers as cam followers, whose quantity is 2;

e04—end cover members, placed inside the spherical inner cavity and fixed with the upper body of the rotor housing;

e05—inlet and exhaust ports with valves;

e06—ignition devices;

e08—pivots of the swingors e03.

### DETAILED DESCRIPTION

The valve controllers of the following embodiments can be controlled by electromagnetic control and hydraulic transmission. Valve switch signals are sent to the corresponding valves by detecting the phase relationship between the output rotor and the fixed frame member. Or according to the layout of the working chamber divided by the cam follower, and valves are timely switched by using the corresponding mechanical transmission system.

### Embodiment I

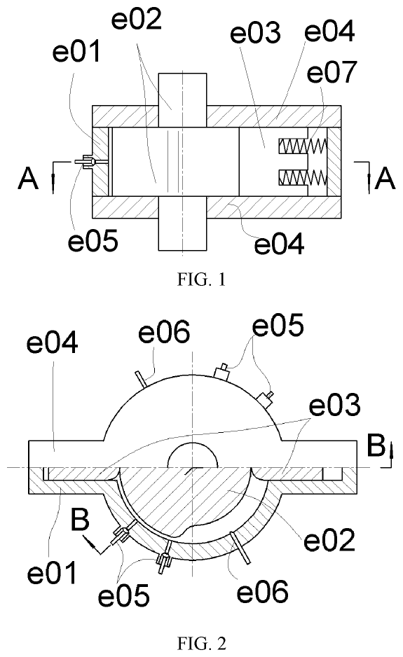

As in FIG. 1 and FIG. 2, FIG. 1 is front view of a basic structure, and is a cross-sectional view through BB section of FIG. 2 which is the overhead view of FIG. 1. Meanwhile, FIG. 2 corresponds to the A/A section in FIG. 1. Rotor housing e01 has an inner cylindrical surface, and the rotor e02 is formed by combining a cam shaft with a cam which has an outer plate contour profile with a high dwell section and a low dwell section, both of whose interval angle are close to 180°. The cam followers, are straight moving sliders e03 with a number of 2. Each of the sliders e03 are installed in a radial slot disposed in the rotor housing and keep in contact (closure) with the cam contour profile by the actual force of springs e07. Because of the small number of sliders, there is no slider capture-release device. The end cover member e04 is fixed sealingly with the rotor housing and forms a dynamic seal with the cam via its end-faces. There is a gap between the high dwell section of the cam contour profile and the inner cylindrical surface in the rotor housing, and then the annular clearance with the change of radial size is formed. The sliders e03 are connected with the end cover member e04 to form dynamic seals, and the contact point between the sliders e03 and the cam contour profile also form dynamic seals, and then two working chambers are separated. The inlet and exhaust ports e05 and ignition devices e06 are introduced into the working chambers from the outside of the rotor.

Fixation of the rotor housing e01 in this embodiment is conducive to the realization of gas distribution. When the rotor e02 rotates, the volume of the two working chambers increases and decreases synchronously. In the chamber with increased volume, if the inlet valve opens and the exhaust valve closes, the intake process of the Otto cycle is performed; otherwise, if both of the inlet and exhaust valves are closed, power process of the Otto cycle is performed. But On the other hand, in the chamber with reduced volume, if the inlet and exhaust valves are both closed, the compression process of the Otto cycle is performed, and if the exhaust valve is opened and the inlet valve is closed, the discharge process of the Otto cycle is performed. When working normally, the intake and exhaust valves should not be opened at the same time. In this case, the increase and decrease in the volume of each working chamber is carried out in a cycle, so the intake, compression, work and exhaust process, that is, the Otto cycle, can be changeable accordingly by valve control. At the beginning of the power phase, the compressed gas in front of or on the top of the high dwell section of the cam will quickly transfer to the rear of it along the narrow gap and then explosion to produce push torque to the cam rotor, thus accelerating the rotation of the rotor.

### Embodiment II

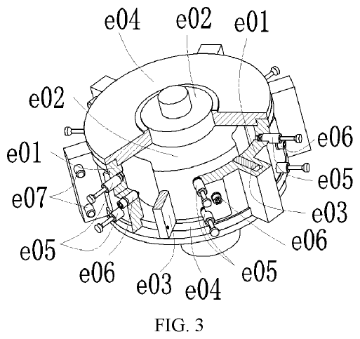

As shown in FIG. 3, this embodiment is the outcome by modifying the Embodiment I, in which the number of the cam follower sliders e03 is increased to 6 uniformly distributed circumferentially, and slider capture-releases device are provided. Besides, The number of high and low dwell sections on the rotor e02 are both set 2, and arranged circumferential symmetrically. The radial angle of the arc length of the high dwell section is about 70°, which is slightly larger than the centripetal angle of the adjacent two sliders, comparatively, the centripetal angle of the low dwell sections is approximately 90°. The requirement for seal structure is the same as the previous embodiment and no longer restated. Grooves for installing sliders also forms independent sealing slots with the end cover members e04, and can be filled with compressed gas or hydraulic oil so that the sliders and the cam contour profile can be keep in contact (force-closed); inlet and exhaust ports e05 with the valves, ignition devices e06, are introduced into the working chambers from the outer side of the rotor housing. The capture-release devices of each slider are arranged on the outer side of the sliding slots of the rotor housing, and the relevant control is carried out externally; and the valve controllers and the inner rotor are linked to send valve switch signals or to drive valves (linkage structure not shown).

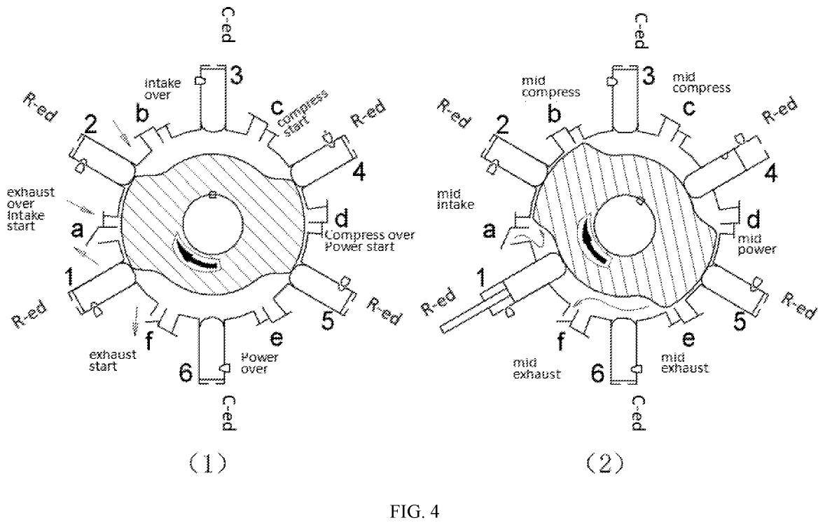

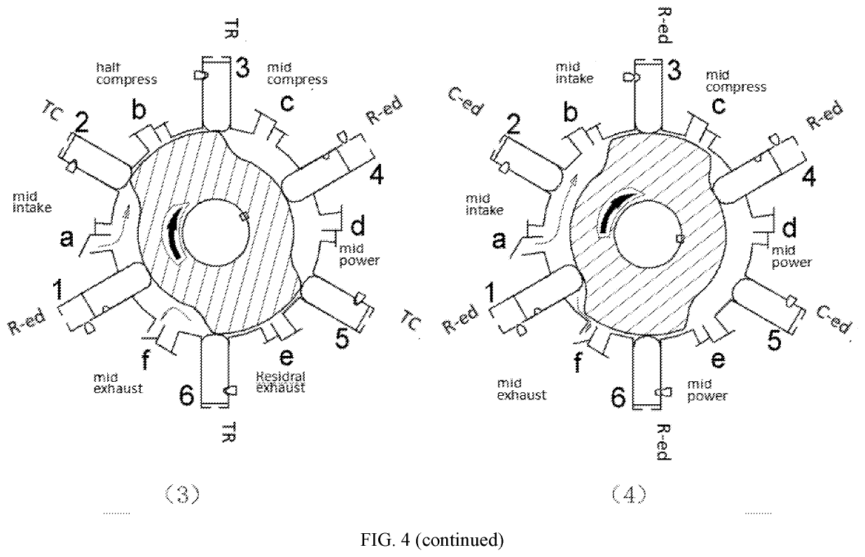

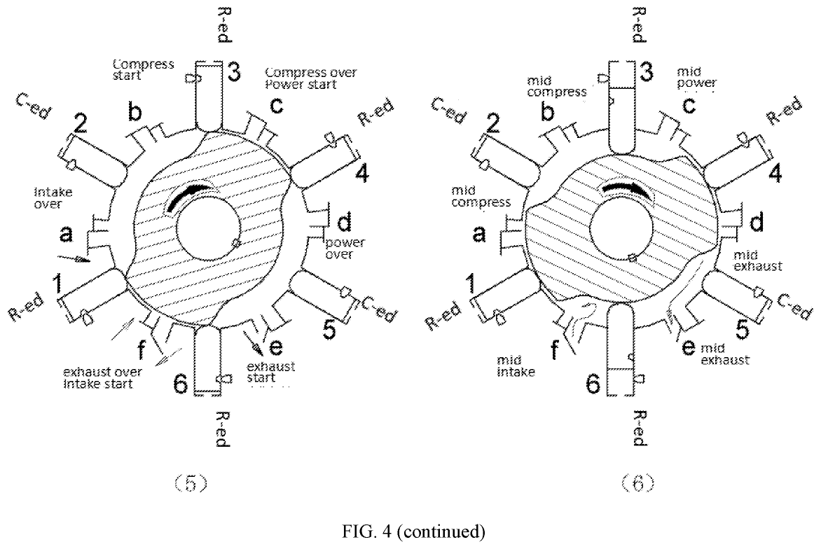

FIG. 4 shows a working mode fragment of this embodiment to illustrate its working process and flexible control characteristics.

In FIG. 4, each slider, identified by a number, is independently controlled by the slider capture-release device, and then 6 sliders can be combined into different number of working chambers. For example, if none slider is captured by any slider capture-release device, there will be 6 geometric working chambers available; otherwise, 5, 4, 3 or 2 working chambers are available temporarily according to the number of sliders in control when the capture-release devices hereof are in action.

At any beginning moment, the work state in each chamber can correspond to at least two different working processes. When the volume of a chamber increases, it can correspond to an intake or a power process. When the volume of a chamber decreases, it can correspond to a compression or an exhaust process. And when the volume does not change, it can correspond to a rest process after an intake or a power process, during which the intake and exhaust valves remain closed and so the volume of the working chamber is unchanged, but heat exchange process accompanied. Therefore, a variety of different working modes can be combined.

FIG. 4 shows that a four-chamber working control mode is adopted, where the number of sliders stuck periodically at the same time is two, and the adjacent geometric working chambers are used in controlled combination, and each chamber is set to intake, compression, work and exhaust in turn according to the rotation direction of the cam rotor. The rotation direction of the rotor is shown by an arc arrow. The flow of gas in the working chamber is represented by an arrow curve.

In FIG. 4, the sign “R-ed”, shorten by “released”, indicates the state that the slider has already been released by the capture-release device, and the sign “C-ed”, shorten by “captured”, indicates the state that the slider has already been stuck by the capture-release device, and the “TC” indicates the timing when the slider is captured by the capture-release device, and the “TR” indicates the timing when the slider is released by the capture-release device. The “TC” and the “TR” are both happened at the top dead center of sliders to avoid the impact of the slider movement. A group of inlet and exhaust ports is illustrated by the letters a, b, c, d, e or f, in which, for distinction, the slightly longer is the inlet port, and the slightly shorter exhaust port. The operation timing of the air valve is shown by the small arrow in the figures, and the state of the valves are maintained without the arrow.

The working process of a working chamber is abbreviated as “intake”, “compression”, “power”, “exhaust”; and “start” meaning beginning, “mid” meaning in progress and “over” meaning the process over. The ignition is not marked which is in between compression and power. In addition, “half compress” means that the gas is only compressed to half way and no longer compressed, and “residual exhaust” refers to the residual exhaust gas from the combustion chamber.

The process of work is as follows:

In FIG. 4 (1), the working chamber which port #a corresponds to is independent and ready for air intake; sliders #3 and #6 are be-captured non-protruding. The working chambers originally corresponding to port #b and port #c are combined together, and ready to compress. The working chamber corresponding to port #d will, independently, perform power process after ignition. The working chambers originally corresponding to ports #e and #f are also combined, and ready to exhaust.

In FIG. 4 (2), due to the released state of sliders #1 and #4, they can be extended to the low dwell section under the action of closed force along the fall interval of cam contour profile so that boundaries between the chambers can be maintained. With cam rotating slightly, states move forward: that is, the volume of the chamber with port #a expands where air intake; the volume of the combined chambers with ports #b and #c decreases where compresses; the chamber with port #d execute power process, accelerating rotor forward rotation, volume increases; and the chamber combined by chambers originally with ports #e and #f decreases and exhaust. At this moment, sliders #2 and #5 engage with the cam surface in releasing state, keep the chamber boundary, until be retracted into the chute and be captured by the capture-release device. Meanwhile, the slider #3 and #6 are trapped in the chute in the state of captured, so they do not engage with the cam, and do not form a boundary of chamber, no extruding under this condition otherwise knocking on the cam.

In FIG. 4 (3), after the sliders #3 and #6 reach the top of rise interval of the cam, and engage smoothly sealingly with the high dwell section of the cam, the releasing action can be executed and reconstruct a new chamber boundary without causing any impact. The process of each chamber progresses again, and then, the chambers corresponding to ports #b, and #e are independent so that a six-chamber discrete state is restored. At this time, the slider #3 intercepts the half-compressed gas in the chamber with port #b, and the slider #6 blocks spent gas residual-discharged from the port #e chamber. Sliders #2 and #5 are already retracted in the chute, being able to execute capture action, easy to convert next time.

In FIG. 4 (4), the cam continues to rotate, slider #2 and #5 are captured no longer slipping out and keep sealing. As sliders #3 and #6 have taken over the seal, chambers originally with ports #a and #b combined together, among which the semi-compressed gas in the chamber with the port #b is mixed into the intake process. The chamber originally with ports #e and #d are also combined and reorganized, and then the residual-discharged gas in chamber with port #e is mixed into the work process. At the same time, the chambers with port #c and port f perform power and exhaust processes independently, respectively. Processes continue in each chambers.

In FIG. 4 (5), until the cam rise section pushes the sliders #4 and #1 back into the chute, the combined chamber with ports #a and #b complete the intake, a combination intake and comparatively larger quantity of gas thereof; the compression in chamber with port #c is finished, a combined compression and be ready for ignited; the power process is completed in the combined chamber with ports #d and #e, during which a comparatively longer angle has been drive, and exhaust process is completed in the chamber with port #f, realizing cooperative exhaustion.

At this point, the four processes at the first stage in each chamber have been completed, and ready for the next process correspondingly, when the cam angle is about 120°. Compared with FIG. 4 (5) and FIG. 4(1), the initial state is the same except that the angle position is minus 60°, and the relationship between FIG. 4(6) and FIG. 4 (2) is the same. As a result, it can be deduced that the rotor will return to its original state after two turns of rotation, so it will no longer be fully displayed.

In this embodiment, if no slider is controlled at all, the rotor can complete an Otto cycle (but not in the same working chamber) as a whole every 120° rotation, and so the power process can be done 3 times per revolution, but two revolutions are needed when the Otto cycle are finished in every 6 chambers. The working process can be continuously circulated infinitely output energy properly even with absence of energy storage devices like flywheel. Further, changing combination of the initial process mode of the chambers, the valve control mode and/or the slider capture-release mode, will offer a greatly different output characteristics of power.

This embodiment shows that a large number of controllable cam followers make the size of the working chambers adjustable in use, increase the flexibility of the power output, and also help to improve the geometric utilization rate of the working chambers and the utilization rate of fuel energy, and have outstanding advantages. From the analysis of maneuverability and system structure complexity of follower and valve control, electromagnetic control means should be the most convenient, although the follower capture-release device and valve controller can also be realized by mechanical transmission or by hydraulic transmission.

### Embodiment III

As shown in FIG. 5, an inner contour cam and an inner cylindrical surface shell are combined to form the inner contour cam rotor e01. The inner contour cam is a straight generatrix radial type with two low dwell sections and the two high dwell sections symmetrically arranged. Both of the low dwell sections have a central angle of about 70 degrees, while both of the high dwell sections have a central angle of about 90 degrees. The central fixing frame e02, which has an outer cylindrical surface, is fixed as frame on which 6 swingors (oscillating cam followers) e03 are installed uniformly distributed. So, the centripetal angle of the low dwell sections is slightly bigger than the inferior centripetal angle between the two of adjacent swingors. Gaps are reserved between the low dwell sections of the inner contour cam and the outer cylindrical surface of the central fixing frame e02. The upper and lower end cover parts e04 are fixed sealingly with the cam rotor e01. The coupled surfaces between cam rotor e01 and the central fixing frame e02 form dynamic seal too, so as to form an annular clearance changing in the radial direction. Each of the swingors e03 has a pivot and a corresponding swingor groove on the central fixing frame e02 with a nose engaged sealingly with the cam inner contour surface, while their upper and lower end surfaces are also in dynamic sealing with the upper and lower end cover members e04, so that the annular clearance is divided into 6 geometric working chambers by these 6 swingors. Besides, 6 other separate seal cavities are constructed by means of the swingor grooves, the swingor e03 and two end cover members e04, and then compression gas or hydraulic oil can be introduced to these cavities forced the swingor e03 closure with the cam contour profile. Some other means such as air inlet and exhaust ports e05 with the valves, fuel filling device e06, swingor capture-release device e07 may all disposed on the central frame e02 and each of which may be controlled internally electromagnetically. The valve controllers e08 send valve switching signals or a drive valves in conjunction with the outer rotor.

This embodiment disposed with fuel filling devices without ignition, which is suitable for compression ignition of diesel fuel. If ignitions are added or the fuel filling devices are changed into ignitions, other fuels are also applicable. The working process for the alteration is similar to that of Embodiment II and is no longer discussed. This embodiment, adopting the central frame e02 fixed and the external parts output, can not only use the end part but also middle part of the outer rotor to make a required output terminal structure.

### Embodiment IV

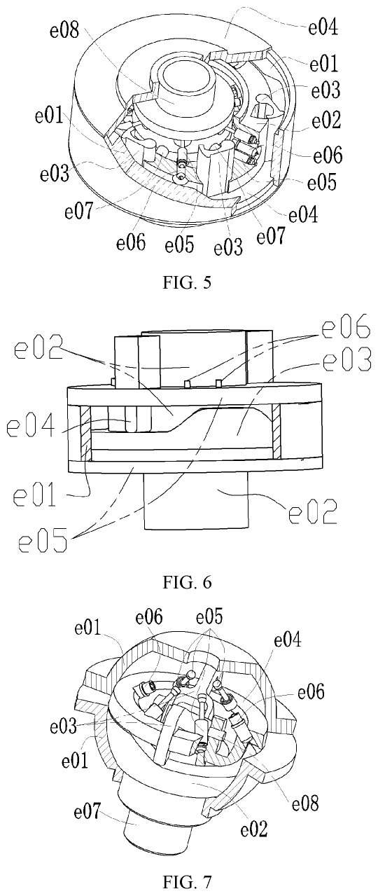

FIG. 6 shows an example of the system structure based on a cylindrical end-face cam. The rotor housing e01 acting as the fixed frame has a cylindrical inner surface. The upper and lower end cover members e05 are fixed sealingly to the rotor housing e01. An inner rotor is comprised of a central camshaft e02 and a cam e03 combining sealingly with each other by a couple of cylindrical surfaces. The axial cam e03 has a high dwell section and a low dwell section. The combined inner rotor is installed concentric in the rotor housing e01 through the upper and lower end cover members e05. Moreover, the outer cylindrical surface of the axial cam e03 is dynamically sealed with the inner surface of the rotor housing e01. Both end cover members e05 and the camshaft e02 are dynamically sealed by couples of surfaces, but there exists a gap between the inward surface of the upper end cover members e05 and the contour profile of the high dwell section of axial cam e03, so as to form an annular gap varying axially. The dynamic seal of the lower end cover member e05 and the lower end face of the axial cam e03 is beneficial to enhance the sealing effect. The cam followers are the 2 sliders e04 installed on the upper end cover members e05 and translating along axis of the cam. The sliders e04 also forms dynamic seals with the outer cylinder surface of the central camshaft e02, the inner cylinder surface of the rotor housing e01 and the cam contour profile surface all time. And then the 2 sliders e04 separate the annular gap into 2 working chambers. The inlet and exhaust ports e06 with valves, the ignition devices (undrawn) are also set sealingly on the upper end cover member e05.

The working process of this embodiment is similar to that of embodiment 1 and is no longer restated. Both the rotor housing and the central camshaft are cylinders, which are easy to manufacture and seal, and are suitable for making slender structures.

### Embodiment V

FIG. 7 shows an example of a system structure based on spherical structure.

The inner cavity is spherical rotor housing e01, which is divided into upper and lower parts. The lower body is also used as the lower end cover member and sealed. The central camshaft e07 is combined with a spherical section space cam e02 to form the cam rotor. The cam has a high dwell section and a low dwell section, both of their concentric angle are slightly less than 180°. The cam followers are 2 swingors e03 symmetrical arranged. An end cover member e04 is placed inside of the spherical cavity fixed sealingly with the upper half of the rotor housing e01, and it also has outer spherical configuration engaging with inner sphere of the cam e02 to form contact seal. But there is clearance for gas communication between the cam-ward surface of end cover member e04 and the high dwell section of the cam e02, thus forming uneven annular clearance. Swingors e03 are installed on end cover member e04 with pivots e08 whose axis through the ball center. The dynamic seal is formed among the lower hemispherical surface of the rotor housing e01, the cam contour profile surface and the outer sphere of the end-cover member e04, so as to separate 2 working chambers. The intake and exhaust ports e05 with valves and the ignition devices e06 are also installed on the end cover member e04.

The working process of this embodiment is similar to Embodiment 1.

The composition, operation mode and application characteristics of internal combustion engine power system are illustrated by several simple embodiment. As you can imagine, as long as the size is large enough, there is no limit to the number of cam followers. At the same time, there is no limit to the number of cam peaks similar to the high and low dwell sections, so the number of working chambers can be determined according to the demand. Coupled with the control to the cam followers by capture-release devices and to the valves by the valve controller, the design flexibility and the flexibility of use can be fully reflected. As for volume of a single chamber, compression ratio, combustion chamber shape and so on, the size of radial clearance and axial length can be fully used to solve the problems. In a word, this invention opens up a broad space for the research of rotor engine.

1. A power system of cam rotary internal combustion engine, comprising an inner cavity member, an external rotating surface member, a cam, end cover members, cam followers, valves and valve controllers; wherein, rise and fall intervals of the cam's contour profile causing size change of the cam surface, an annular clearance with varied dimension being formed by encircling the cam with the inner surface of the inner cavity rotating surface member, the outer surface of the external rotating surface member and the end cover members, in which the coupled surfaces form the contact sealing relationship except the cam contour profile; the cam being fixed with one of the inner cavity member or the external rotating surface member and rotated relative to the other; a set of cam followers being installed on the inner cavity member or the external rotating surface member which is not fixed with the cam, sealing contact being formed by a higher pair joints between the cam followers and the smooth cam contour profile surface, so as to separate the annular clearance into a plurality of sealing working chambers along the circumferential direction;
under the control of valve controllers, valves being used to connect the inlet and exhaust ports in each chambers, and to control flow direction of fuel or spent gas in an orderly manner; by controlling the timing of the valve switch and the volume change of each working chamber, the intake, compression, expansion and exhaust phases of Otto cycle being completed periodically; in the expansion stroke, the chemical energy produced by fuel combustion being acted on the cam contour profile and cam followers in the form of high pressure, so that the mechanical energy being output by the two in the form of relative rotating motion.

2. The power system of cam rotary internal combustion engine according to claim 1, wherein the cam contour profile is a smooth and closed surface constructed by tracing synchronously changing generatrix around an axis on the inner or outer surface of the rotating body, and the contact between the cam follower and the cam keeps sealing during relative rotation.

3. The power system of cam rotary internal combustion engine according to claim 2, wherein the cam contour profile is a radial cam formed on the surface of a base cylinder with a plane curve generatrix, an axial cam formed on the end face of a cylinder, or a cam formed on a spherical body.

4. The power system of cam rotary internal combustion engine according to claim 3, wherein the cam contour profile has one or more high dwell sections and/or one or more low dwell sections, and all transition areas of the cam rise and fall intervals make the cam follower free from rigid impact and/or flexible impact when moving, that is, no step change in velocity and acceleration curves; and the arc length corresponding to the high dwell section and/or the low dwell section are close to or equal to the arc length corresponding to the contact ends of the adjacent two cam followers.

5. The power system of cam rotary internal combustion engine according to claim 4, wherein the cam follower are in type of translating or oscillating, or of plane motion, whose contacting end with the cam are chosen from smooth curved surface, roller or combination equipped with a movable swing head, whose number is greater than 2, and whose structure is single body, multi-piece or multi-segment combination.

6. The power system of cam rotary internal combustion engine according to claim 5, further comprising cam follower capture-release devices, the function of which are to timely seize or release cam followers to realize flexible control of the working process; the arc corresponding to the high dwell section or the low dwell section grows longer than the arc length corresponding to the contact ends of the two adjacent cam followers; meanwhile, the follower capture-release device and valve controls are achieved electromagnetic or mechanically.

7. The power system of cam rotary internal combustion engine according to claim 1, further comprising ignition devices and/or a fuel filling devices, the ignition devices are arranged in the corresponding position of the combustion chamber when the mixture reaches a specified compression ratio, and the fuel injection inlets are arranged in the corresponding intervals between the intake process and the compression process.

8. An engine comprising the power system of cam rotary internal combustion engine according to claim 1.

9. A method for controlling an engine, wherein, the method is applicable to the control of cam followers and/or valves in the power system of cam rotary internal combustion engine of claim 8.
